(19) United States
(12) Patent Application Publication
(10) Pub. No.: US 2015/0330822 A1
(43) Pub. Date: Nov. 19, 2015

(54) Dry Product Dosage Dispenser and Method for Producing Same

(71) Applicant: The Quaker Oats Company, Chicago, IL (US)

(72) Inventor: Thomas Branton WATSON, Chicago, IL (US)

(73) Assignee: The Quaker Oats Company, Chicago, IL (US)

(21) Appl. No.: 14/278,110

(22) Filed: May 15, 2014

(51) Int. Cl. G01F 11/28; G01F 15/18; G01F 15/00

(52) U.S. Cl. CPC G01F 11/282; G01F 15/001; G01F 15/18

(57) ABSTRACT

An internal capsule for receipt of dry product is suspended within a canister with a dispensing cap on its top end. The capsule is secured inside the canister so as to maintain an open space within the canister, which forms a chamber for the dispensing of the dry product. The dry product passes through an outlet at the bottom end of the capsule and, when the canister is flipped, through the open space within the canister and out the opening in the dispensing cap. The canister may comprise an adjustable volume compartment on its bottom end for dispensing variable amounts of dry product.

### BACKGROUND OF THE INVENTION

1. Technical Field

The present invention generally relates to dispensers of dry goods and, more particularly, the dosage dispensing of dry or solid products, including edible dry substances or solids used in the preparation of foods or drinks

2. Description of Related Art

Current food packaging products are aimed at providing consumers with ease of use, for example, with opening sealed packaging and/or re-sealing food products therein for future use or consumption. When dispensing of products in predetermined or measured quantities (i.e, a dose) is desirable, often times additional valves, springs, latches, conveying tools, turnkeys or other somewhat complex mechanisms are added within or onto the packaging. Traditionally, more cost effective efforts for dosage dispensing include the introduction of measuring cups, caps, or spoons within or onto the packaging. More recently, advances have been made in the area of liquid dispensing packaging in measured amounts such as with liquid detergent. However, in the area of dry goods, including edible solids, there remains a need for a convenient, cost-effective, package that saves both time and effort for a consumer when dispensing specific predetermined desirable amounts. Ideally, the packaging would also provide for variable adjustable dosing amounts depending on the changing needs or preferences of one or more consumers.

### SUMMARY OF THE INVENTION

In one aspect of the present disclosure, a dry product dosage dispenser comprises a canister with two ends. An internal capsule for receipt and storage of a dry product is suspended and secured within the canister by one or more support members. The open volume or space remaining within the open ends of the canister form a dispensing chamber through which the dry product will pass once it is able to exit from the internal capsule through an outlet at its bottom end. The bottom end of the internal capsule may be funneled down to help direct the product down through the outlet.

In relation to its upright position, at an upper or top end of the canister, the dosage dispenser may comprise a dispensing cap with an exit port through which the dry product is ultimately dispensed. At the lower or base end of the canister, the dosage dispenser may comprise an integral or permanently attached bottom end. This allows for the dispensing of one single, specific amount of dry product to be consistently delivered from the dispenser. Alternatively, the dosage dispenser may comprise an adjustable volume compartment on the lower or base end of the canister to provide for adjusting of the open volume and therefore, a plurality of predetermined amounts to be possible from the dispenser.

The lower or base end may further comprise an internal disbursement cone adjacent to the outlet of the bottom end of the internal capsule to help direct the dry product into the dispensing chamber.

When flipped from its upright position, the dry product, having exited the outlet of the internal capsule, is free to flow through the open volume of the canister and through the exit port of the dispenser.

Embodiments comprising an adjustable volume compartment further provide for the sealing of the dry product within the internal capsule prior to any desired dispensing by simply adjusting the adjustable volume compartment so that its interior bottom is pushed or placed against the outlet of the internal capsule, thereby preventing the dry product from exiting into the dispensing chamber.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1A is an exploded view of one embodiment of the dispenser.

FIG. 1B is a cross sectional view of the embodiment depicted in FIG. 1A.

FIG. 2 depicts a perspective cross-sectional view of one embodiment of the internal capsule of the dispensing device having dry product placed therein.

FIG. 3A depicts a perspective view of the exterior of the internal capsule in one embodiment of the dispensing device.

FIG. 3B is a cross-sectional view of the embodiment of FIG. 3A showing dry product therein.

FIG. 4 depicts the dry product flow within the dispensing device when in the upright position.

FIG. 5 depicts the dry product flow from the dispensing device when turned to dispense the product in one embodiment.

FIG. 6A is a cross-sectional view of one embodiment of the dispensing device when substantially closed.

FIG. 6B is a cross-sectional view of one embodiment of the dispensing device when adjusted to receive a measured quantity of dry food from the internal capsule.

FIG. 6C is a cross-sectional view of one embodiment of the dispensing device when adjusted to receive a measured quantity of dry food from the internal capsule.

FIG. 7 is a cross-sectional view of one embodiment of the dosage-dispensing device having an integral bottom end.

### DETAILED DESCRIPTION OF THE INVENTION

A dry product dosage dispenser 5 described herein may be used for dispensing doses of a dry product. As used herein, a “dry product” for use with the dispenser is meant to refer to any solid or non-liquid product capable of freely flowing under the influence of gravity such as those having granular, flake, grain, or powder qualities. In one embodiment, the dry product is meant to more specifically encompass a dry food product, dry food, solid food product, or an edible dry product, whether ready for direct consumption or for use in the preparation of foods for consumption, including without limitation grains, granular materials, flakes, and fine particles such as powders. By way of example, the dry product dispenser described herein can be used for any number of dry product including without limitation coffee grounds or beans, sugar (granulated or powdered), seeds, spices, oats, cereals, nuts, grains, baking powder, and seasonings as well as dry laundry detergent, sand, and salts useful for purposes other than food such as de-icing salt. In one embodiment, the dry product comprises an edible dry product selected from one or more of oats, cereals, seasonings, peanuts, almonds, cashews, pecans, pistachios, dried fruits, kernels, and sunflower seeds.

The dry product dosage dispenser will now be described with reference to the figures. In accordance with one aspect of the present disclosure, a dry product dosage dispenser 5 comprises a canister 20 having inner walls, a dispensing cap 28 on one end and a base end on an opposing end, the dispensing cap 28 comprises an exit port 30; and an internal capsule for storage of dry product, said internal capsule 10 suspended and secured within the canister 20 to provide a dispensing chamber 26 within the canister, the internal capsule 10 having a lid 12 on its upper end and a bottom end comprising an outlet 16; wherein the dispensing chamber 26 comprises an open volume between the internal capsule 10 and the inner walls of the canister 20 for passage of the dry product 11 from the outlet 16 of the capsule 10.

In one embodiment, the dispensing cap 28 is removable to ensure easy access to an internal capsule 10 that fits inside the canister 20. The internal capsule 10 comprises a hollow interior for the placement and storage of a dry product to be dispensed, as further described below. A lid 12 seals the internal capsule 10 closed on a top end. In one embodiment, the lid 12 of the internal capsule 10 is removable for selectively exposing a storage area for the dry product and for the refilling of the product to be dispensed. In one embodiment, the interior of the internal capsule 10 consists of a storage area, which is hollow until product is added within the internal capsule 10.

In one embodiment, the base or bottom end of the canister 20 comprises an adjustable volume compartment 24, for adjusting the open volume of the dispensing chamber. Alternatively, the base end may comprise a fixed end. In one embodiment, the fixed end is integral to the canister 20. In one embodiment, the base end further comprises an interior disbursement cone, the apex of which is faces the interior of the canister 20. In one embodiment, the adjustable volume compartment comprises the disbursement cone, with the apex facing the outlet of the capsule. In one embodiment, the dispenser 5 described herein comprises an axially symmetric configuration.

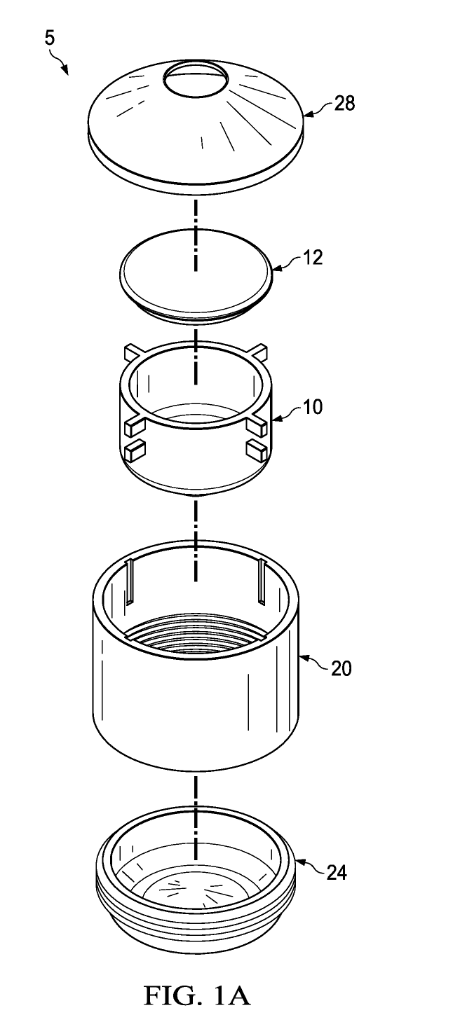

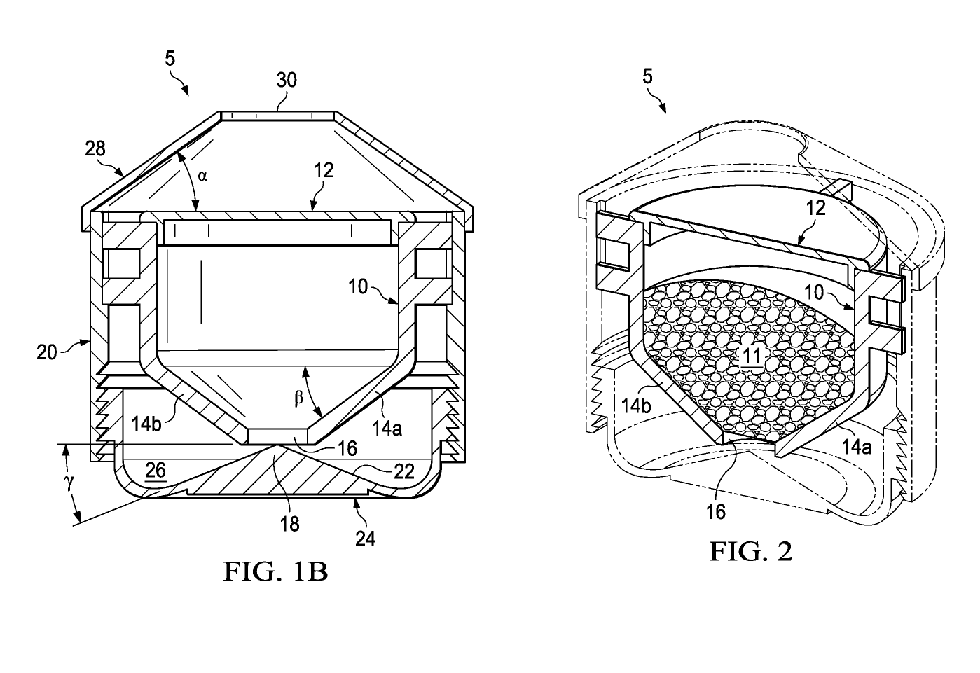

FIGS. 1-4 and 6a-c depict one embodiment of the dispenser 5 when standing in an upright position on its own. The dispensing cap 28 is located above the supply container, or capsule 10, in which dry product is placed or stored. The dispensing cap 28 is joined to the top end of the canister 20. In one embodiment, the dispensing cap 28 is removably attached to the top end of the canister 20. In one embodiment, the dispensing cap 28 comprises a conical shape with a base wider than its top outlet end, the base being attached to the rim of the canister 20 such that the walls of the dispensing cap taper away from the canister 20 in towards an outlet 30. The shape of the dispensing cap 28 thus acts as a funnel to channel the dry product to a specific area for dosing. As best shown beginning with FIG. 1B, the base of the dispensing cap 28 may comprise a rim around its circumference that is slightly larger than the circumference at the top of the canister 20 with which it engages. The rim of the dispensing cap 28 securely fits around the top of the canister 20 and ensures a snug fit that is maintained during dispensing processes (i.e., when the dispenser 5 is turned upside down or rotated in any direction). While the dispensing cap 28 is shown in the Figures to comprise a rim, any secure or tight connection between the dispensing cap 28 and canister 20 is acceptable so long as the dispensing cap remains in place during dispensing. For example, the dispensing cap and/or the canister may comprise a snap-fit or threads to secure the dispensing cap to the canister.

In one embodiment, the dispensing cap 28 of the canister 20 is conical with sides tapering away from the canister 20 and up to the exit port 30. The sides of the dispensing cap 28 taper up and away from the canister 20 and into a narrowed exit port 30, through which dry product is dispensed as will be described in more detail below. In the embodiment shown in the Figures, the exit port 30 of the canister 20 comprises a circular opening formed in the center of the dispensing cap 28. In other embodiments, the exit port 30 may be off center and may comprise any number of shapes or sizes, depending on the product to be dispensed and/or the desired size of the dispenser 5 overall. In some embodiments, for example, the diameter or greatest size of the exit port 30 from end to opposing end ranges from about ¼ inch to about 3 inches. In other embodiments, the size of the exit port from one end to the opposite end is from about ¾ inch to about 1½ inches. By way of example, the angle α of the conical or frustoconical shape of the dispensing cap 28 in relation to a horizontal plane on top of the canister 20 may range from about 15 to about 80 degrees. In some embodiments, the sides of the dispensing cap 28 form an angle α of about 30 to about 45 degrees.

The term “about” with regard to the angle values provided herein may encompass a range of +10 percent to −10 percent of the stated value. The angles discussed herein generally control how quickly the product exits the doser. Therefore, one skilled in the art would recognize the angle may vary according to the dry product size or flow rates.

As depicted in the Figures, the internal capsule 10 comprises a smaller size than that of the canister 20 such that the internal capsule 10 fits within the canister 20. The internal capsule 10 is suspended and secured within the canister 20 such there is created within the canister 20 an open volume or space between the canister 20 and the capsule 10. In one embodiment, the internal capsule 10 is suspended and secured within the canister by one or more supporting members within the canister 20 such that the internal capsule 10 is substantially free on all of its exterior sides except at the point of support. In other embodiments, the internal capsule 10 may be attached along a side to the capsule so long as there remains a dispensing chamber in communication with the outlet of the internal capsule and the exit port of the canister or dispensing cap. In one embodiment, the internal capsule 10 comprises a cylindrical shape similar to that of the canister 20. FIG. 1A depicts a plurality of tabs on the exterior of the capsule 10, with which the internal capsule 10 attaches to the canister 10 via a plurality of grooves within the interior side of the canister 20. While tabs are shown, the capsule 10 may be secured to the canister 20 by any means known in the art including without limitation press fitment or glue so long as the connection does not interrupt the substantially open volume or area between the exterior wall of the capsule 10 and the interior walls of the canister 20 in such a manner that would prevent the flow of product through the exit port 30. In one embodiment, the capsule 10 and canister 20 are bonded together permanently to form one integral structure. In another embodiment, the capsule 10 may be removably secured to the canister 20.

The internal capsule 10 also comprises a lid 12 on its upper end to help seal the product within the capsule 10. In the embodiment as depicted in the Figures, the lid 12 is a unitary flat piece. In one embodiment, the lid 12 of the internal capsule 10 is substantially flat along its top surface. In one embodiment, the lid 12 of the internal capsule 10 is substantially flat along its bottom surface. The lid 12 may also be entirely flat along one or both of its surfaces. However, other embodiments may comprise some form of curvature or other deviation in geometrical shape so long as the product flow, described below, remains uninterrupted and so long as product storage within the capsule remains possible.

In one embodiment, the lid 12 is removable to selectively expose a storage area for the dry product 11. In one embodiment, the lid 12 comprises a circumferential rim or flange that engages and seals against the upper end of the internal capsule 10. As perhaps best shown in FIGS. 1A and 1B, the bottom of the lid 12 may comprise a lower wall or rim around its bottom side circumference that is slightly smaller than the circumference at the lip of the upper end of internal capsule 10 with which it engages. The lid 12 further comprises a circumferential rim around its top surface that rests against the upper end of the internal capsule 10. The rim of the lid 12 securely fits around the upper end of the internal capsule 10 and ensures a snug fit that is maintained during dispensing processes (i.e., when the dispenser 5 is turned from its upright position). While the lid 12 is shown to comprise a rim that engages the upper end of the internal capsule 10, any secure or tight connection between the lid 12 and the internal capsule 10 is acceptable so long as the lid 12 remains in place during dispensing.

In another embodiment, the lid 12 may be permanently placed onto the capsule 10 to maintain quality of the product therein or to provide for one time dispensing of a product 11. The lid may, for example, be placed onto the capsule with an adhesive or it may be integral to the internal capsule.

FIG. 2 depicts a cross sectional view of the canister with focus on the internal capsule 10 having dry product 11 placed within its storage area. In one embodiment, the internal capsule 10 is centered within the canister such that the open volume forming part of the dispensing chamber surrounds the entire exterior walls or perimeter of the internal capsule 10. The dispensing chamber thus comprises a circumferential open volume within the canister 20 and around the internal capsule 10 in one embodiment. The storage compartment within the capsule 10 may be provided with a funnel-type bottom that includes a conical surface that terminates in an opening. Thus in one embodiment, the bottom end of the internal capsule 10 tapers down into the outlet. As shown beginning in FIG. 1B, the bottom end of the internal capsule 10 tapers inwards into an outlet 16. The walls 14a, 14b of the bottom end angle down towards a base end of the canister 20. In one embodiment, depicted in FIGS. 1-6, the outlet lead inwards and points down towards the adjustable volume compartment 24. Thus, the bottom end of the capsule 10 is configured in the shape of a cone that funnels inward and down when the canister 20 is in an upright position. In one embodiment, the walls 14a, 14b taper down into a circular or annular opening 16. In one embodiment, the opening 16 is centered at the bottom end of the capsule 10. Other embodiments wherein the opening 16 is slightly off-center may also be possible so long as the opening 16 comes into proper contact with the interior side of the adjustable volume compartment 24 or its disbursement cone 18, if present, for proper sealing of the product within the internal capsule 10, as further discussed below. In one embodiment, the walls 14a, 14b comprise an angle β of between about 20 and 65 degrees with respect to a horizontal plane parallel to the capsule lid. In one embodiment, the walls 14a, 14b comprise an angle β of between about 30 and about 60 degrees. In one embodiment, the walls 14a, 14b comprise an angle β of between about 35 and about 55 degrees.

The size of the outlet 16 of the internal capsule 10 may vary depending upon the product to be stored for dispensing and the overall size of the dispenser. Generally, the smaller the product, the smaller the size of the dispenser 5 and the outlet 16. Similarly, larger products would require a larger dispenser with a larger outlet 16. By way of example and without limiting the potential size the outlet, the outlet 16 of the internal capsule 10 may comprise a diameter of between about 0.75 inch to about 1.5 inches. For example, the outlet 16 comprises a diameter no greater than about 3.5 inches and no smaller than about 0.25 inch.

In one embodiment, the open volume of the canister 20 is adjustable by way of lengthening the canister 20. This embodiment provides not only for various dosage amounts to be dispensed, but also for sealing of the product within the internal capsule 10. When sealing of the dry product 11 within the internal capsule 10 is desired, the base end of the canister 20 comprises a bottom interior side, said bottom interior side engaging the bottom end of the internal capsule 10 to seal the dry food within the internal capsule when the dispenser 5 is in a closed position. In particular, the bottom interior side of the base end should engage the outlet of the bottom end of the internal capsule 10 to prevent dry product 11 from passing therethrough. In one embodiment, the bottom interior side of the base end of the canister may comprise a disbursement cone for engaging the outlet of the capsule when sealing product within the internal capsule 10. As depicted in FIGS. 1-6, in one embodiment, the base end of the canister 20 comprises an adjustable volume compartment 24, which is opposite to the dispensing cap 28 of the dispensing device. In one embodiment, the adjustable volume compartment 24 comprises the disbursement cone 18 on its bottom interior side, the disbursement cone 18 facing the outlet 16 of the internal capsule 10. In one embodiment, the disbursement cone 18 is directly across form the outlet 16. When the length of the canister is adjustable, the disbursement cone 18 may contact or engage the outlet 16 at the bottom end of the hollow internal capsule to seal the dry product 11 within the capsule 10 when the dispenser 5 is in a closed position. Inclining walls 22 of the disbursement cone 18 angle up to form the cone shape that tapers smoothly from a flat base to an apex. In one embodiment, the angle χ of the walls 22 in relation to a horizontal plane parallel to a flat capsule lid 12 ranges from about 5 to about 45 degrees. In one embodiment, the angle χ of the walls 22 ranges from about 20 to about 30 degrees.

In accordance with the embodiment depicted in the FIGS. 1-6, in one embodiment, the adjustable volume compartment 24 comprises a circumferential rim extending about a periphery of the adjustable volume compartment 24, said rim for mating with the base end of the canister 20. In one embodiment, the circumferential rim comprises threading for mating with corresponding threading 32 near the base end of the canister 20 such that the adjustable volume compartment 24 is adjusted, for example, by way of rotation through a screw interface. In one embodiment, the canister 20 comprises an internal female threaded interface, while the adjustable volume compartment 16 comprises an exterior male threaded interface. Opposing threaded interfaces are also possible in other embodiments. While the connection is shown as threads, other popular means of attachment could also be used by those skilled in the art so long as the volume between the internal partition and the adjustable volume compartment is lengthened or enlarged, including without limitation a sliding mechanism. In principle, both the dispensing cap and the adjustable volume compartment on opposing ends of the canister can be releasably connected to the canister by any state-of-the-art connection.

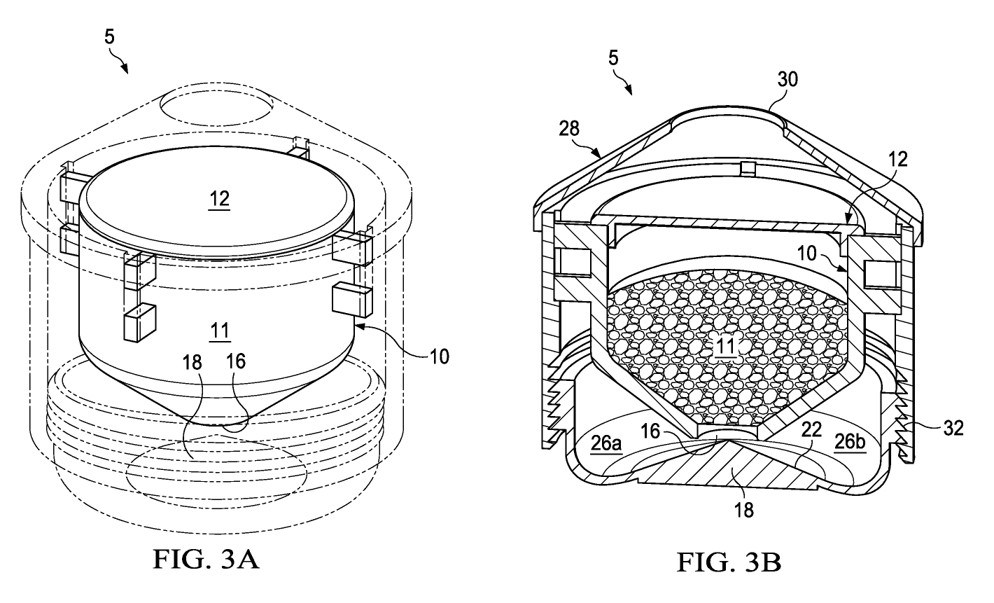

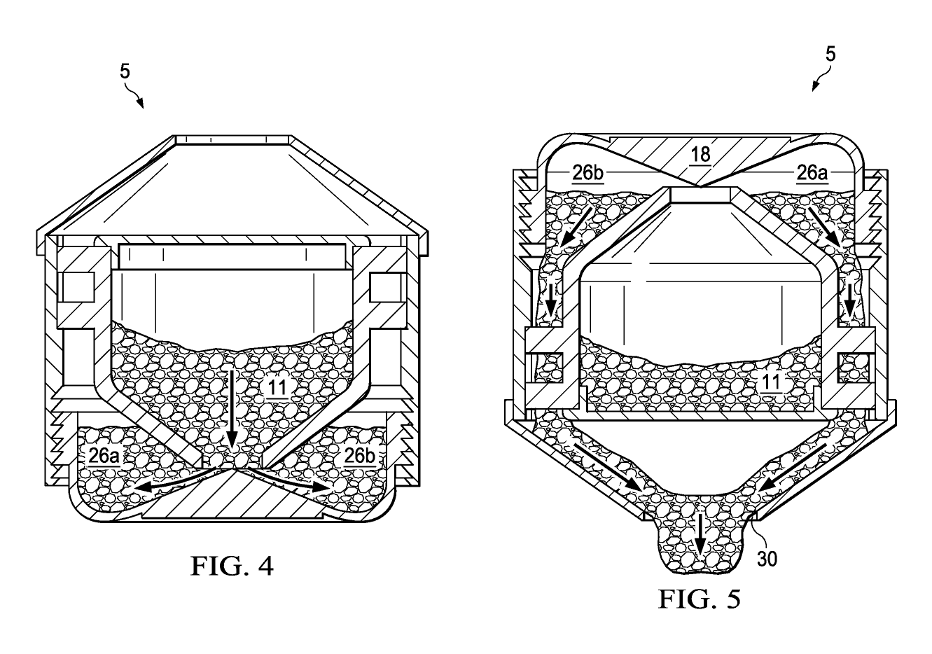

In one embodiment, the dispensing chamber 26 comprises or consists of the open volume within the canister 20 through which dry product 11 may flow once it exits from the internal capsule 10. In one embodiment, the open volume 26a, b within the canister 20 is substantially circumferential and surrounds the internal capsule along its exterior. As shown in FIG. 3B, in one embodiment, the dispensing chamber 26 a,b comprises that portion surrounding the funneled outlet 16 of the capsule 10 and the disbursement cone 18. The dispensing chamber further comprises the open volume above the lid 12 and within the dispensing cap 28, as will be made further apparent by the description of FIGS. 4 and 5, below.

All components of the dry product dispenser described herein may be made of or comprise one or more of plastic, metal, cardboard, or any other material suitable for storing edible products and/or maintaining moisture of shelf-stable foods. By way of example, one or more components of the dry product dispenser may include without limitation any plastic made of formation techniques such as injection molding or thermoforming (including ABS plastic as ABS-containing plastics or other molded plastic), any cardboard containing materials such as spiral wound cardboard, or any other cardboard whether or not coated with a suitable plastic material to resist moisture and provide some rigidity. For handheld dispensing purposes, it is desirable to keep the dispenser lightweight and portable for easy to use access.

FIGS. 4 and 5 show the flow of dry product during dispensing through an embodiment having an adjustable volume compartment 24. Prior to dispensing, the adjustable volume compartment 24 is moved away from the capsule 10 such that the dry product 11 will begin to flow from the capsule 10 and into the dispensing chamber or open volume within the canister 20. To dispense the dry product, the adjustable volume compartment 24 should be adjusted to increase the volume of the canister. FIG. 4 depicts the flow of dry product within the dispensing device when the adjustable volume compartment 24 is adjusted to provide for more volume, creating a dispensing chamber 26a, 26b, which is in direct communication with the outlet 16. When the adjustable volume compartment 24 is moved away from the canister 20, dry product 11 begins to flow through the outlet 16 out of the capsule 10, hitting the disbursement cone 18, or bottom interior side of the base end of the canister, and entering the surrounding area thereof, or the dispensing chamber 26. This moves the dry product 11 away from the outlet 16 such that when the dispenser 5 is flipped, as in FIG. 5, an uncontrolled amount of dry product 11 will not re-enter the capsule 10. It should be noted that embodiments having a base end comprising an integral bottom end, as shown in FIG. 7, should provide for similar flow of product 11, once the dry product 11 exits from the outlet 16 of the internal capsule 10. As described briefly above, the open volume of the canister forms a dispensing chamber for the dry product 11. When the dispenser is flipped, dry product 11 passes through the dispensing chamber 26 around exterior walls of the internal capsule 10 and along the walls of the dispensing cap to get through the exit port 30. In one embodiment, the dispensing chamber 26 provides for passage of the dry product 11 around the entire periphery or outer perimeter of the internal capsule 10.

In one embodiment, the dispenser 5 is turned from its upright standing position by an angle of at least 45 degrees for proper dispensing. Other embodiments that flip the dispenser greater than 45 degrees will allow for faster exit of dry product from the dispenser. During dispensing, only a very small amount of product (less than 1%) may re-enter the product storage area or internal capsule 10. Thus, the dispenser 5 provides for consistent amount of dry product to be dispensed at any given time so long as the dispenser 5 is flipped so that product flows down and substantially around the capsule 10 into the open space of the canister 20 and out the exit port 30. While only two arrows are shown in the cross-sectional views, it should be understood that the product actually flows around the surface of the capsule 10 within the open volume of the canister 20.

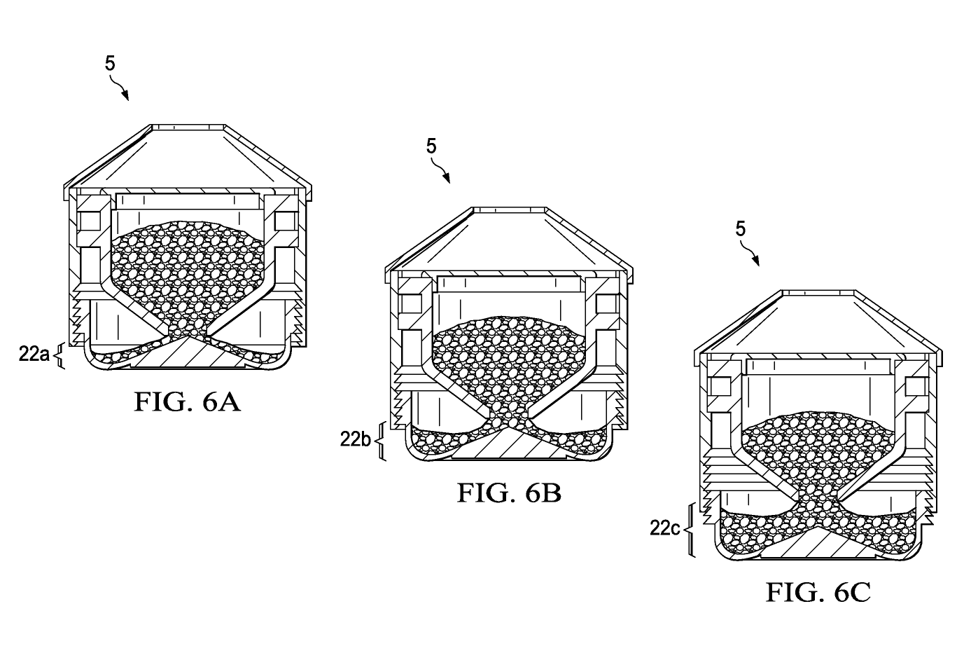

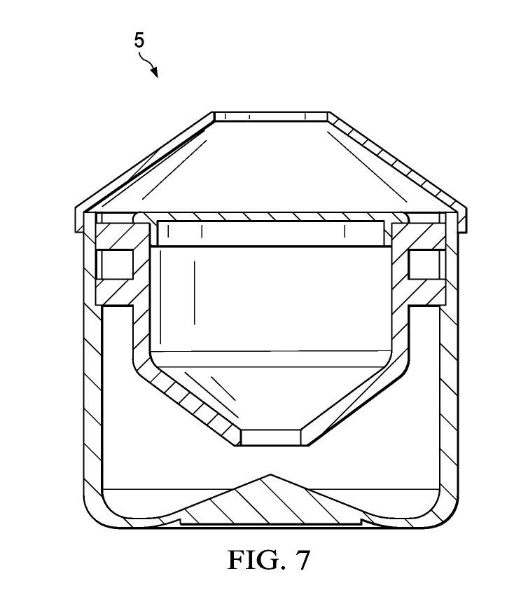

FIGS. 6A-6C depict one embodiment of the dispensing device in various adjustment positions for dispensing a plurality of measured or pre-determined quantities of dry product. FIG. 6A shows slight adjustment for smaller volume 22a and, therefore, smaller amount of dry product to be dispensed. FIG. 6B shows increased volume 22b for dispensing a greater amount of product. In FIG. 6C, the volume 22c is further increased for more product. The adjustable volume compartment 24 may comprise, on its exterior, marked measurements for consumer reference in some embodiments. As made apparent by FIGS. 6A-C, the adjustable volume compartment allows for various amounts of product to be dispensed to account for larger serving sizes, different products and consumer preference, for example. Controlling the adjustable volume compartment directly effects how much product is dispensed. The larger the volume, the more product dispensed with each dose or turn of the dispenser. Conversely, the smaller the volume, the less product dispensed. It should be noted that in some embodiments, the volume of the adjustment compartment could also be fixed to consistently deliver the same amount of product with every use.

As shown in FIG. 7, the lower or base end of the canister 20 may also comprise an integral bottom end, where no adjustment of the volume is possible. This embodiment provides for a single, predetermined amount to be consistently dispensed from the dispenser 5 at any given time so long as the dispenser is flipped back to its upright position to allow for dry product to again fall from the internal capsule through the outlet and into the dispensing chamber.

In accordance with another aspect of this disclosure, a method of producing an apparatus for dispensing a dry product is presented. The method comprises the steps of providing a canister 20 having inner walls, an upper end, and a lower end; and placing an internal capsule 10 within the canister 20, said internal capsule 10 comprising an interior, an exterior, a bottom end with an outlet 16, and a lid 12 covering a storage area for the dry product, wherein the internal capsule 10 is suspended and secured within the canister 20 by a supporting member, thereby forming a dispensing chamber 26 between the exterior of the internal capsule 10 and the inner walls of the canister 20 and to an exit port 30. The dispensing chamber is therefore in communication with the outlet 16, providing passage for the dry product 11 therein to the exit port 30.

In one embodiment, the method further comprises the step of placing a dispensing cap 28 on the upper end of the canister 20, the dispensing cap 28 comprising a conical shape with sides tapering away from the canister 20 and up to the exit port 30. In one embodiment, the internal capsule 10 comprises a funneled bottom end that tapers down into the outlet 16. In one embodiment, the lid 12 of the internal capsule 10 is removable.

The lower or base end of the canister may comprise one of an integral bottom end, a fixedly attached bottom end, or an adjustable volume compartment. Thus in one embodiment, the method further comprises the step of placing an adjustable volume compartment at the lower end of the canister, said adjustable volume compartment 24 capable of adjusting a volume of the dispensing chamber. The volume is generally the open volume within the canister 20, outside the internal capsule 10. In one embodiment, the step of placing an adjustable volume compartment 24 may comprise the attachment of the adjustable volume compartment 24 to the lower end of the canister 20 by way of a threading mechanism, which allows a screw interface between the adjustable volume compartment and the canister. Any attachment that allows for adjusting of the length of the dispenser 5 may be used to place the adjustable volume compartment 24 at the lower end of the canister 20, as describe above in relation to the figures.

The lower end or base of the canister 20 may contain a disbursement cone to help direct the flow of product around the outside of the internal capsule 10. Thus in one embodiment, the method further comprises the step of placing or providing a disbursement cone on the lower end of the canister, said disbursement cone comprising an apex on its bottom interior side, said apex facing the outlet of the internal capsule. A disbursement cone may be present on either the interior side of the adjustable volume compartment 24 or an integral bottom end.

As described above, the dosage dispenser may be used for any number of dry, non-liquid goods. For embodiments directed towards the dispensing of an edible dry product, the method further comprises the step of placing an edible food product within the storage area to be dispensed through the dispensing chamber. As described above, a removable lid 12 on the internal capsule 10 will allow for refilling of a dry product or cleaning of the storage area within the internal capsule.

In some embodiments, when sealing the product within the canister is desired, the method may further comprise the step of sealing the canister. Sealing steps may comprise placing tamper proof type seals around any one of: the entirety of the dispenser; only an upper end of the dispenser; or around the exit port of a dispensing cap. Alternatively, the sealing step may comprise placing a detachable portion over the exit port of the dispenser, to be removed by a consumer either through the application of pressure or by opening a flip top cap.

Any specific angles and sizes of the openings provided herein help ensure consistent and more desirable (i.e., user-friendly) flow rates from the dispenser in some embodiments and may be varied according to the specific dry product. The outer geometry of the internal capsule 10 works in tandem with the dispensing chamber 26 to allow product to flow around in the substantially open area between the capsule 10 and the canister 20 and then out through the dispensing cap when the dispenser 5 is flipped. However, moderate changes in the geometry or angles mentioned herein would still allow for dispensing of dry product though perhaps not delivering a consistent or specific dosage every time. Accordingly, discussion of angles and sizes is for illustrative purposes only and not intended to limit the scope of all embodiments unless otherwise noted.

The motion for dispensing is simple and convenient and provides for one-handed operation with no additional components such as a spring, latch, turnkey, conveying tool, motorized drive mechanism, valve, valving device, separate measuring spoon, scoop, cap, metering screw, rotating wheel, rolling pin devices, etc. Thus, in one embodiment, the dispenser 5 may consist of only the five components shown in the Figures for convenient and consistent delivery of dry product from within the dispenser; that is, the canister 20 with dispensing cap 28, the internal capsule 10 with lid 12, and the adjustable volume compartment 24, whether or not the components are permanently or removably attached. Optionally, the dispenser 5 may also comprise sealing caps such as external tamper bands or the like to indicate when the product is fresh and the dispenser 5 has never been opened. The dispenser 5 may further optionally comprise a product level window or similar indicator to show how much product has been dispensed or remains.

While this invention has been particularly shown and described with reference to certain embodiments, it will be understood by those skilled in the art that various changes in form and detail may be made therein without departing from the spirit and scope of the invention. The inventor expects skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Additional Description

1. A dry product dosage dispenser comprising: a canister having inner walls, a dispensing cap on one end, and a base end on an opposing end, wherein said dispensing cap comprises an exit port; and an internal capsule for storage of dry product, said internal capsule suspended and secured within the canister to provide a dispensing chamber within the canister, said internal capsule having a lid on its upper end and a bottom end comprising an outlet; wherein the dispensing chamber comprises an open volume between the internal capsule and the inner walls of the canister for passage of the dry product from the outlet of the capsule.

2. The dry product dosage dispenser according to clause 1 wherein the base end comprises an adjustable volume compartment for adjusting the open volume.

3. The dry product dosage dispenser according to clause 2 wherein the adjustable volume compartment comprises a disbursement cone with an apex on its bottom interior side, said apex facing the outlet of the capsule.

4. The dry product dosage dispenser according to any one of the preceding clauses wherein the dispensing cap of the canister is removable.

5. The dry product dosage dispenser according to any one of the preceding clauses wherein the lid of the capsule is removable for selectively exposing a storage area for the dry product.

6. The dry product dispenser according to any one of the preceding clauses wherein the internal capsule is centered within the canister.

7. The dry product dosage dispenser according to any one of the preceding clauses wherein the bottom end of the internal capsule tapers down into the outlet.

8. The dry product dosage dispenser according to any one of the preceding clauses wherein the base end comprises a bottom interior side, said bottom interior side engaging the bottom end of the internal capsule to seal the dry food within the internal capsule when the dispenser is in a closed position.

9. The dry product dosage dispenser according to any one of the preceding clauses wherein the base end is adjustable for adjusting the open volume and comprises a bottom interior side, said bottom interior side comprising a disbursement cone engaging the outlet of the capsule to seal product within the capsule.

10. The dry product dosage dispenser according to any one of the preceding clauses wherein the dispensing cap of the canister is conical with sides tapering away from the canister and up to the exit port.

11. The dry product dosage dispenser according to any one of the preceding clauses wherein the open volume is substantially circumferential and surrounds the internal capsule along its exterior.

12. The dry product dosage according to any one of the preceding clauses wherein the lid of the capsule is substantially flat along its top surface.

13. The dry product dosage dispenser according to any one of the preceding clauses wherein the dry product is an edible food product.

14. The dry product dosage dispenser according to any one of clauses 1, 4-7, and 10-13 wherein the base end of the canister comprises an integral bottom end.

15. A method of producing an apparatus for dispensing a dry product, the method comprising the steps of: providing a canister having inner walls, an upper end, and a lower end; and placing an internal capsule within the canister, said internal capsule comprising an interior, an exterior, a bottom end with an outlet, and a lid covering a storage area for the dry product, wherein the internal capsule is suspended and secured within the canister by a supporting member, thereby forming a dispensing chamber between the exterior of the internal capsule and the inner walls of the canister and to an exit port.

16. The method according to clause 15 further comprising the step of placing a dispensing cap on the upper end of the canister, said dispensing cap comprising a conical shape with sides tapering away from the canister and up to the exit port.

17. The method according to any one of clauses 15-16 wherein the internal capsule comprises a funneled bottom end that tapers down into the outlet.

18. The method according to any one of clauses 15-17 wherein lid of the internal capsule removable.

19. The method according to any one of clauses 15-18 further comprising the step of placing an adjustable volume compartment at the lower end of the canister, said adjustable volume compartment capable of adjusting a volume of the dispensing chamber.

20. The method according to any one of clauses 15-19 further comprising the step of placing or providing a disbursement cone on the lower end of the canister, said disbursement cone comprising an apex on its bottom interior side, said apex facing the outlet of the internal capsule.

21. The method according to any one of clauses 15-20 comprising the step of placing an edible food product within the storage area to be dispensed through the dispensing chamber.

22. The method according to any one of clauses 15-21 comprising the step of sealing the canister.

We claim:

1. A dry product dosage dispenser comprising:
a canister having inner walls, a dispensing cap on one end, and a base end on an opposing end, wherein said dispensing cap comprises an exit port; and
an internal capsule for storage of dry product, said internal capsule suspended and secured within the canister to provide a dispensing chamber within the canister, said internal capsule having a lid on its upper end and a bottom end comprising an outlet;
wherein the dispensing chamber comprises an open volume between the internal capsule and the inner walls of the canister for passage of the dry product from the outlet of the capsule.

2. The dry product dosage dispenser of claim 1 wherein the base end comprises an adjustable volume compartment for adjusting the open volume.

3. The dry product dosage dispenser of claim 2 wherein the adjustable volume compartment comprises a disbursement cone with an apex on its bottom interior side, said apex facing the outlet of the capsule.

4. The dry product dosage dispenser of claim 1 wherein the dispensing cap of the canister is removable.

5. The dry product dosage dispenser of claim 1 wherein the lid of the capsule is removable for selectively exposing a storage area for the dry product.

6. The dry product dosage dispenser of claim 1 wherein the internal capsule is centered within the canister.

7. The dry product dosage dispenser of claim 1 wherein the bottom end of the internal capsule tapers down into the outlet.

8. The dry product dosage dispenser of claim 1 wherein the base end comprises a bottom interior side, said bottom interior side engaging the bottom end of the internal capsule to seal the dry food within the internal capsule when the dispenser is in a closed position.

9. The dry product dosage dispenser of claim 1 wherein the base end is adjustable for adjusting the open volume and comprises a bottom interior side, said bottom interior side comprising a disbursement cone engaging the outlet of the capsule to seal product within the capsule.

10. The dry product dosage dispenser of claim 1 wherein the dispensing cap of the canister is conical with sides tapering away from the canister and up to the exit port.

11. The dry product dosage dispenser of claim 1 wherein the open volume is substantially circumferential and surrounds the internal capsule along its exterior.

12. The dry product dosage dispenser of claim 1 wherein the lid of the capsule is substantially flat along its top surface.

13. The dry product dispenser of claim 1 wherein the dry product is an edible food product.

14. The dry product dispenser of claim 1 wherein the base end of the canister comprises an integral bottom end.

15. A method of producing an apparatus for dispensing a dry product, the method comprising the steps of:
providing a canister having inner walls, an upper end, and a lower end;
placing an internal capsule within the canister, said internal capsule comprising an interior, an exterior, a bottom end with an outlet, and a lid covering a storage area for the dry product, wherein the internal capsule is suspended and secured within the canister by a supporting member, thereby forming a dispensing chamber between the exterior of the internal capsule and the inner walls of the canister and to an exit port.

16. The method of claim 15 further comprising the step of placing a dispensing cap on the upper end of the canister, said dispensing cap comprising a conical shape with sides tapering away from the canister and up to the exit port.

17. The method of claim 15 wherein the internal capsule comprises a funneled bottom end that tapers down into the outlet.

18. The method of claim 15 wherein the lid of the internal capsule removable.

19. The method of claim 15 further comprising the step of placing an adjustable volume compartment at the lower end of the canister, said adjustable volume compartment capable of adjusting a volume of the dispensing chamber.

20. The method of claim 15 further comprising the step of placing or providing a disbursement cone on the lower end of the canister, said disbursement cone comprising an apex on its bottom interior side, said apex facing the outlet of the internal capsule.

21. The method of claim 15 comprising the step of placing an edible food product within the storage area to be dispensed through the dispensing chamber.

22. The method of claim 15 comprising the step of sealing the canister.
